(19) United States
(12) Patent Application Publication
(10) Pub. No.: US 2014/0068474 A1
(43) Pub. Date: Mar. 6, 2014

(54) CONTENT SELECTION APPARATUS, CONTENT SELECTION METHOD, AND COMPUTER READABLE STORAGE MEDIUM

(71) Applicant: JVC KENWOOD Corporation, Yokohama-shi (JP)

(72) Inventor: Megumi NISHIDA, Tokyo (JP)

(73) Assignee: JVC KENWOOD Corporation, Yokohama-shi (JP)

(21) Appl. No.: 14/076,978

(22) Filed: Nov. 11, 2013

Related U.S. Application Data
(63) Continuation of application No. PCT/JP2012/078046, filed on Oct. 30, 2012.

(30) Foreign Application Priority Data
Nov. 30, 2011 (JP) 2011-261542
Nov. 30, 2011 (JP) 2011-261543
Aug. 31, 2012 (JP) 2012-191158
Aug. 31, 2012 (JP) 2012-191159

(51) Int. Cl. G06F 3/0484

(52) U.S. Cl. CPC G06F 3/04842
USPC 715/764

(57) ABSTRACT

In an embodiment, a content selection apparatus includes: a select determining unit configured to determine whether a select manipulation input is input, the select manipulation input being a manipulation input to select a predetermined range on a display screen on which a GUI image including a plurality of category regions is displayed, and the category region being a region to which categories is allocated to sort a content item; a selected region identifying unit configured to identify a region corresponding to a position of the select manipulation input; a time measuring unit configured to measure a selection time period that is a time period involved in the select manipulation input; and a content selecting unit configured to select a number of content items based on the selection time period in accordance with selected category information indicating a selected category region.

### CROSS-REFERENCE TO RELATED APPLICATIONS

This application is a continuation of International Application No. PCT/JP2012/078046, filed on Oct. 30, 2012 which claims the benefit of priority of the prior Japanese Patent Application No. 2011-261542, filed on Nov. 30, 2011, Japanese Patent Application No. 2011-261543, filed on Nov. 30, 2011, Japanese Patent Application No. 2012-191158, filed on Aug. 31, 2012 and Japanese Patent Application No. 2012-191159, filed on Aug. 31, 2012, the entire contents of which are incorporated herein by reference.

### BACKGROUND OF THE INVENTION

1. Field of the Invention

The present invention relates to a content selection apparatus, a content selection method, and a computer readable storage medium that selects content items from a plurality of content items in accordance with user's intent.

2. Description of the Related Art

In these years, the number of items of content data that a user can own becomes enormous because of an increase in the capacity of a recording medium; and it becomes difficult to select a plurality of desired content items from a large number of content items. In such situations, a technique is described in Japanese Patent Application Laid-open No. 2006-113715 in which the number of content items that a user wants can be intuitively selected by continuously pressing one point on a display.

The technique described in Japanese Patent Application Laid-open No. 2006-113715 is used to intuitively select the number of content items that a user wants at one time. However, only content items in similar tendencies tend to be selected.

### SUMMARY OF THE INVENTION

There is a need to at least partially solve the problems in the conventional technology.

According to an aspect of the present invention, provided is a content selection apparatus that includes: a select determining unit configured to determine whether a select manipulation input is input, the select manipulation input being a manipulation input to select a predetermined range on a display screen on which a GUI image including a plurality of category regions is displayed, and the category region being a region to which a category or a plurality of categories is allocated to sort a content item; a selected region identifying unit configured to identify a region corresponding to a position of the select manipulation input that is selected by the select manipulation input; a time measuring unit configured to measure a selection time period that is a time period involved in the select manipulation input; and a content selecting unit configured to select a number of content items based on the selection time period in accordance with selected category information indicating a selected category region that is a region identified by the selected region identifying unit.

According to another aspect of the present invention, provided is a content selection method that includes: a GUI image generating step of generating a GUI image including a plurality of category regions, the category region being a region to which a category or a plurality of categories is allocated to sort a content item; a selection determining step of determining whether a select manipulation input is input, the select manipulation input being a manipulation input to select a predetermined range on a display screen on which the GUI image is displayed; a selected region identifying step of identifying a region corresponding to a position selected by the select manipulation input; a storage control step of storing selected category information indicating a selected category region identified at the selected region identifying step on a storage unit; and a content selecting step of selecting a predetermined content item from a plurality of the content items based on the selected category information.

According to still more aspect of the present invention, provided is a non-transitory computer readable storage medium on which a content selection program is stored, of which content selection program causes a computer to perform: a GUI image generating step of generating a GUI image including a plurality of category regions, the category region being a region to which a category or a plurality of categories is allocated to sort a content item; a selection determining step of determining whether a select manipulation input is input, the select manipulation input being a manipulation input to select a predetermined range on a display screen on which the GUI image is displayed; a selected region identifying step of identifying a region corresponding to a position selected by the select manipulation input; a storage control step of storing selected category information indicating a selected category region identified at the selected region identifying step on a storage unit; and a content selecting step of selecting a predetermined content item from a plurality of the content items based on the selected category information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a content selection apparatus according to embodiments of the present invention;

FIG. 2 is a schematic diagram of a display unit and a touch panel according to the embodiments;

FIG. 3 is a schematic diagram illustrative of a GUI image according to a first embodiment to a third embodiment;

FIG. 4 is a flowchart illustrative of a content selection method according to the first embodiment;

FIG. 5A is a diagram illustrative of a selection category table according to the first embodiment;

FIG. 5B is a diagram illustrative of a selection category table according to the first embodiment;

FIG. 5C is a diagram illustrative of a selection category table according to the first embodiment;

FIG. 5D is a diagram illustrative of a selection category table according to the first embodiment;

FIG. 5E is a diagram illustrative of a selection category table according to the first embodiment;

FIG. 6 is a diagram illustrative of a selection time period according to the first embodiment;

FIG. 7A is a content list illustrative of a content selection method according to the first embodiment;

FIG. 7B is a content list illustrative of a content selection method according to the first embodiment;

FIG. 8 is a schematic diagram illustrative of another exemplary GUI image according to the first embodiment to the third embodiment;

FIG. 9 is a flowchart illustrative of a content selection method according to the second embodiment;

FIG. 10 is a flowchart illustrative of a content selection method according to the third embodiment;

FIG. 11A is a diagram illustrative of a selection category table according to the third embodiment;

FIG. 11B is a diagram illustrative of a selection category table according to the third embodiment;

FIG. 11C is a diagram illustrative of a selection category table according to the third embodiment;

FIG. 11D is a diagram illustrative of a selection category table according to the third embodiment;

FIG. 11E is a diagram illustrative of a selection category table according to the third embodiment;

FIG. 11F is a diagram illustrative of a selection category table according to the third embodiment;

FIG. 12A is a content list illustrative of a content selection method according to the third embodiment;

FIG. 12B is a content list illustrative of a content selection method according to the third embodiment;

FIG. 13 is a schematic diagram illustrative of a GUI image according to a fourth embodiment;

FIG. 14 is a schematic diagram illustrative of a GUI image according to a fifth embodiment;

FIG. 15 is a diagram illustrative of a selection category table according to the fifth embodiment; and

FIG. 16 is a content list illustrative of a content selection method according to the fifth embodiment.

### DETAILED DESCRIPTION OF THE PREFERRED EMBODIMENTS

In the following, a content selection apparatus, a content selection method, and a computer readable storage medium according to the present invention will be described with reference to the accompanying drawings.

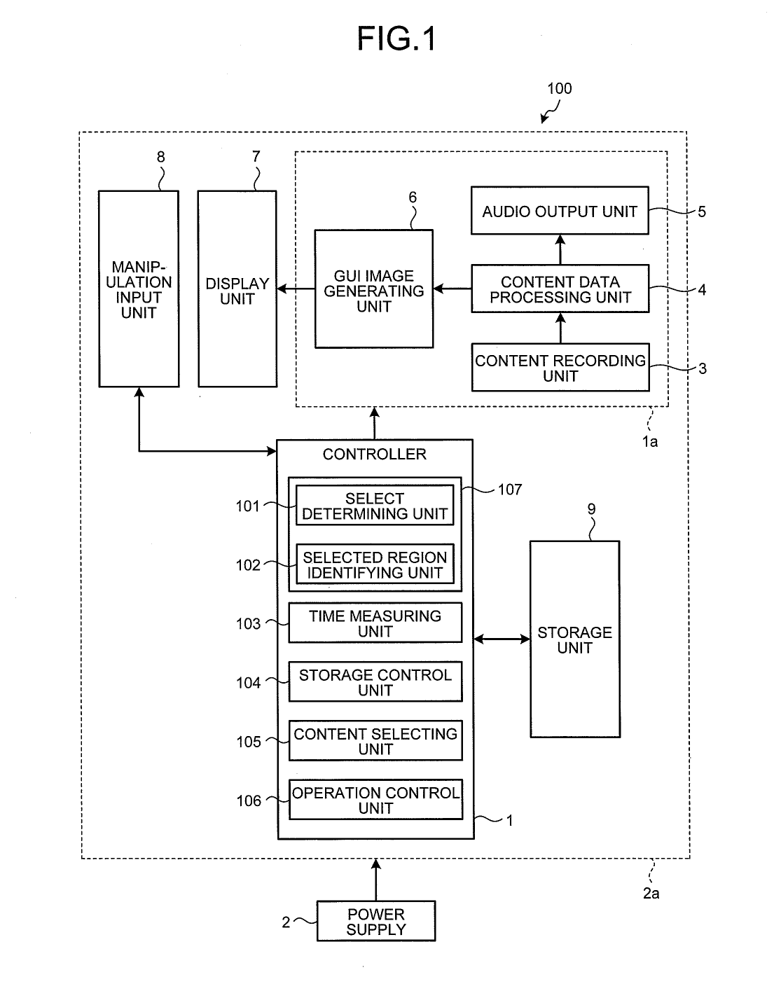

A content selection apparatus 100 according to a first embodiment will be described with reference to a block diagram illustrated in FIG. 1. First, a controlled unit 1a including a content recording unit 3, a content data processing unit 4, an audio output unit 5, and a GUI image generating unit 6 and an operation control unit 106 included in a controller 1 will be described. The operation or the like of the units other than the operation control unit 106 of the controller 1 will be described any time after describing the controlled unit 1a and the operation control unit 106. It is noted that the content selection apparatus 100 adapted to music content and image content will be described as an example. However, the present invention is also applicable to an apparatus that reproduces only music content. In this case, the apparatus may not include functions provided only for image content. Moreover, the present invention is also applicable to an apparatus that reproduces only image content. In this case, the apparatus may not include functions provided only for music content.

The content recording unit 3 stores content data. For example, content data is music content formed of audio data or image content such as music videos and movies formed of image data and audio data. In the case of image content, image data is in synchronization with audio data. The content recording unit 3 also includes a function that outputs data, and outputs audio data and image data included in content data in accordance with the control of the operation control unit 106 described later. For example, a hard disk drive (HDD), flash memory, or the like can be used for the content recording unit 3. The content recording unit 3 may be detachable or not. Moreover, such a configuration may be possible in which the content recording unit 3 is externally provided and the content selection apparatus 100 communicates with the content recording unit 3 through a network for acquiring content data.

The content data processing unit 4 converts audio data output from the content recording unit 3 into audio signals (analog audio signals, for example), and outputs the signals. Moreover, the content data processing unit 4 converts image data output from the content recording unit 3 into picture signals (RGB signals, for example), and outputs the signals in synchronization with audio signals.

The audio output unit 5 includes a speaker and an amplifier, for example, and reproduces the audio signals output from the content data processing unit 4.

The operation control unit 106 adjusts the sound level or sound quality of sounds output from the audio output unit 5. Moreover, the operation control unit 106 controls the GUI (Graphical User Interface) image generating unit 6 according to a manipulation input made by a user. The GUI image generating unit 6 generates a GUI image based on the control of the operation control unit 106, and outputs signals to display the GUI image. It is noted that a CPU, a DSP, or the like can be used for the controller 1 including the operation control unit 106. The controller 1 may be configured using a plurality of CPUs or DSPs, or the controller 1 may be configured using a single CPU or DSP.

In a case where image content is being reproduced, the GUI image generating unit 6 superposes an image based on picture signals output from the content data processing unit 4 onto a GUI image, and outputs signals to display the superposed image signals. It is noted that in a case where no GUI image is output while reproducing picture signals, the GUI image generating unit 6 does not perform processes particularly, and the picture signals output from the content data processing unit 4 are output as they are. Moreover, in a case where picture signals are not being reproduced, or in a case where the function to reproduce image content is not included, signals only to display a GUI image are output. In the outputting, such a configuration may be possible in which the GUI image generating unit 6 superposes a GUI image onto a given background image and outputs signals to display the superposed image signals. It is noted that the GUI image generating unit 6 may generate GUI images by simply reading images recorded on the content recording unit 3 or recorded on other recording units, not illustrated.

A display unit 7 displays images based on signals output from the GUI image generating unit 6. A liquid crystal panel or an organic electroluminescent panel, for example, can be used for the display unit 7. A power supply 2 then supplies electric power to a power supplied unit 2a.

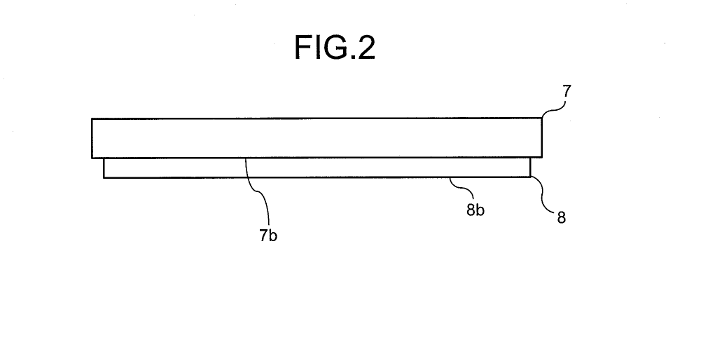

A remote controller, a mouse, a touch panel, or the like can be used for a manipulation input unit 8, to which the user inputs a manipulation input. As illustrated in FIG. 2, for example, in a case where a touch panel is used for the manipulation input unit 8, the touch panel is disposed as laid on the display unit 7 in such a way that a manipulation surface 8b to detect a manipulation input on the touch panel is provided in parallel with a display surface 7b to display images on the display unit 7 as a manipulation to the touch panel is matched with a GUI image. In this manner, a manipulation to the touch panel can be matched with a GUI image. It is noted that for the touch panel, various touch panels can be used such as an electrostatic capacitance touch panel and a resistance film touch panel.

In the following, for example, an example where a touch panel is used for the manipulation input unit 8 will be mainly described. However, examples that a remote controller or a mouse is used for the manipulation input unit 8 will be supplementally described as necessary. Moreover, in the following description, music content will be taken as an example for description.

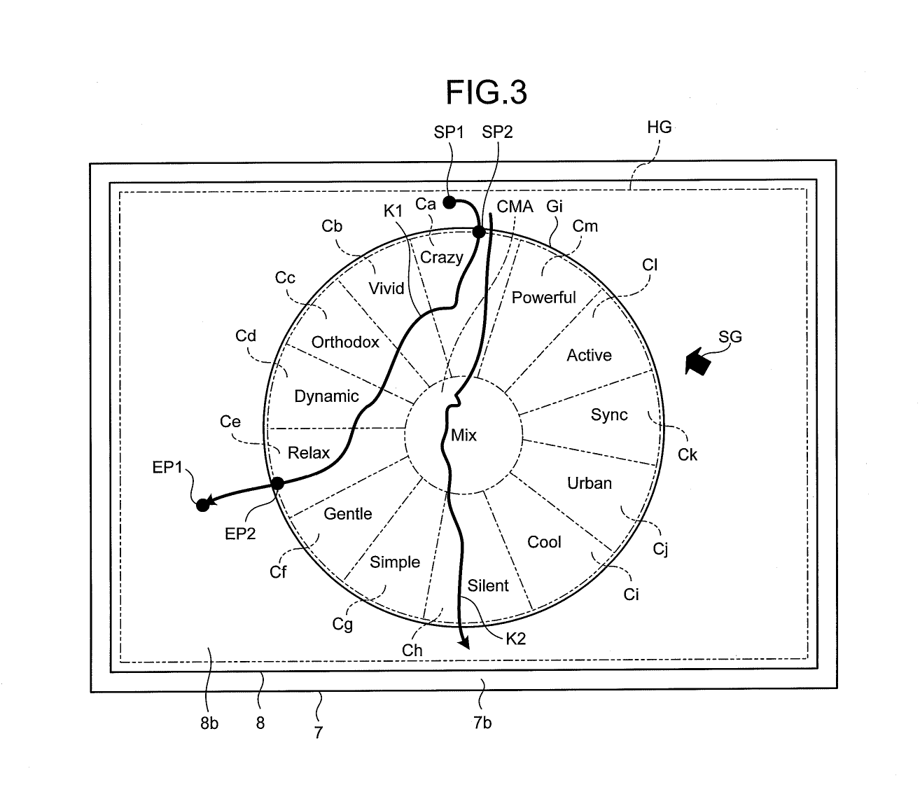

Furthermore, in the description of the embodiments, “to select” means a selection of any one position on the inside of a display screen HG as illustrated in FIG. 3 by pressing a button on a remote controller, clicking a mouse, contacting a pointing device on a touch panel (or bringing a pointing device close to a touch panel), or the like. The pointing device means a bar-shaped pointer to manipulate a touch panel by or a user finger.

For example, in a case where the button on the remote controller is pressed down in the state in which an instruction image SG corresponding to a manipulation to a remote controller is displayed on a predetermined region in the inside of the display screen HG, this predetermined region is to be selected. Moreover, in a case where a mouse is clicked in the state in which an instruction image SG corresponding to a mouse manipulation is displayed on a predetermined region in the inside of the display screen HG, this predetermined region is to be selected. Furthermore, in a case where a pointing device is contacted or brought close to a predetermined position on the touch panel corresponding to the inside of a predetermined region on the display screen HG of the display unit 7 provided as corresponding to the touch panel and a select determining unit 101, described later, detects the contact or closeness of the pointing device, this predetermined region is to be selected.

Next, a GUI image Gi generated at the GUI image generating unit 6 will be described with reference to FIG. 3. As depicted by long dashed double-short dashed lines in FIG. 3, the GUI image Gi is sectioned into a plurality of category regions C (Ca to Cm, and CMA). The category regions C are allocated with a category or a plurality of categories to sort a plurality of content items recorded on the content recording unit 3. The boundaries between the category regions C may be distinguishable or not distinguishable. The boundaries are depicted by long dashed double-short dashed lines for description in FIG. 3. It is noted that in a case where a touch panel is used for the manipulation input unit 8, the manipulation surface 8b of the touch panel is also virtually sectioned as corresponding to the regions of the GUI image Gi. It is noted that in a case where a touch panel is used, the instruction image SG may not be displayed as in a case where a mouse or a remote controller is used. Moreover, a solid line depicting the GUI image Gi and long dashed double-short dashed lines depicting the plurality of category regions C are illustrated as the lines are not matched with each other. However, the lines may be configured as matched with each other.

Furthermore, the category is information to sort genres such as rock music, pop music, and classical music and content such as artist names, album titles, years including time of starting sale, and tunes (musical characteristics), for example. In a case where content is images, genres including movies, music videos, and comedies, producers, and years including time of release can be used as categories. It is noted that these categories are examples, and various other categories can be used. Content data includes metadata indicating which category a content item belongs to. A content selecting unit 105, described later, can select a content item belonging to an indicated category.

It is noted that tunes may be calculated by various publicly known methods, or allocated with impressions of songs by a listener. It is noted that in a case where a tune is calculated, the content selection apparatus 100 may calculate a tune, or may make a reference to a calculated result done at a different device.

For a method of calculating a tune, such a method can be used, in which an acoustic feature value is generated from the acoustic signals of a piece of music; and the acoustic feature value is used to generate an impression word. More specifically, first, an acoustic feature value is calculated from acoustic signals by a method disclosed in Japanese Patent Application Laid-open No. 6-290574 or Japanese Patent Application Laid-open No. 2002-278547, for example; a set of pieces of music for learning is then prepared; impression words such as Crazy and Vivid, for example, are given; and a rule is created in which an acoustic feature value is converted into an impression word using a publicly known decision tree, the Bayes' rule, etc. The created conversion rule is used to generate impression words. It is noted that a decision tree and the Bayes' rule are merely examples. Impression words may be allocated using other schemes that can obtain outputs equivalent to the outputs of a decision tree and the Bayes' rule.

Moreover, for a method of extracting acoustic feature values, a technique disclosed in Japanese Patent Application Laid-open No. 2007-322598, for example, may be used. Furthermore, in addition to this, such a configuration may be applicable in which audio signal strength, frequency distribution, tempo, beat strength, and the like are detected for acoustic feature values. Furthermore, such a configuration may be applicable in which audio data is analyzed to determine a section in which it can be estimated that music is recorded in audio data and an acoustic feature value is extracted from the section.

It is noted that in a case where a tune is used for a category, an acoustic feature value may be calculated when an occasion arises, without using metadata. In addition, information related to tunes may be acquired via a network. Moreover, such a configuration may be applicable in which category information is acquired via a network for the other categories when an occasion arises.

In FIG. 3, categories related to tunes are allocated to the category regions Ca to Cm, for example. In the embodiment, the category regions Ca to Cm are allocated with categories related to tunes, Crazy, Vivid, Orthodox, Dynamic, Relax, Gentle, Simple, Silent, Cool, Urban, Sync, Active, and Powerful, respectively. Moreover, the category region CMA is allocated with all the categories allocated to the category regions Ca to Cm. When the category region CMA is selected, content items are randomly selected from all the content items. In this case, preferably, the number of content items may be equally selected from the categories. However, the selection is not limited thereto. Furthermore, the number of the category regions C allocated to the GUI image Gi is not limited to 13 types described above.

The GUI image Gi is not necessarily of a circular shape. However, content items can be easily selected on the circular GUI image Gi by a single manipulation input like a track K1. It is noted that the GUI image Gi is not necessarily of a perfect circular shape. For example, content items can be easily selected by a single manipulation input also with a shape of ellipse or the like. The circular shape of the embodiment also includes an ellipse or the like. Moreover, the GUI image Gi is not necessarily of a shape in which the plurality of category regions C is disposed in the circumferential direction of a circular shape adjacent to each other with no space, as illustrated in FIG. 3. The GUI image Gi may be of a shape in which the plurality of category regions C is disposed with spaces. The plurality of category regions C is disposed adjacent to each other with no space; so that content items can be easily selected by a single manipulation input like the track K1 or a track K2. It is noted that in a case where the category regions C are disposed, as illustrated in FIG. 3, preferably, such that similar category regions are arranged adjacently each other, or in closer distances in the circumferential direction. With this arrangement, for example, content items can be selected as songs are gradually transitioned from louder songs to quieter songs, or content items can be selected as songs are gradually transitioned from older to later in their contents. As described above, when the GUI image Gi is in a circular shape, a plurality of content items that user's intent is more considered can be selected from a large number of content items with simple handlings, even though content items are not selected based on the selected time period.

Moreover, the foregoing category region CMA is not necessarily provided. However, the category region CMA is provided near the center of the circle, so that it can be prevented that tunes, for example, are suddenly changed as in a case where the user makes a manipulation input that passes through near the center of a circle as the track K2. For example, in the case of the track K2, when the category region CMA is not provided, tunes suddenly changes from a content item belonging to the category Crazy to a content item belonging to the category Silent. However, when the category region CMA is provided, a content item belonging to a different category is reproduced in the midway point of the transition from a content item belonging to the category Crazy to a content item belonging to the category Silent; and a natural order of reproducing content items can be provided. This transition is effective when tunes between category regions opposite to each other across the center of a circle are greatly different, for example.

Next, a content selection method according to the embodiment will be described with reference to FIGS. 3 to 8. The content selection method according to the embodiment is a method in which a time measuring unit 103 measures a time period involved in a select manipulation input that is a manipulation input to select a predetermined range on the display screen HG on which the GUI image is displayed; and a predetermined content item is selected from a plurality of content items based on information indicating a selection time period that is a time period involved in the select manipulation input.

It is noted that the selection time period in the embodiment means a time period in which the user starts to select a content item and the user ends the selection of a content item. More specifically, in the embodiment, the selection time period is a time period from the state in which the selection of any one position on the inside of the category regions C is started to the state in which any one position on the inside of the category regions C is not selected. In this case, the inside of a predetermined range on the foregoing display screen HG means the inside of the category regions C. As described above, when a predetermined range is limited to the positions on the inside of the category regions C, it is highly likely that a manipulation input is a manipulation input involved in selecting a content item, so that a content item with user's intent more considered can be selected. In this case, the selection time period means a time period from a point in time at which any one position on the inside of the category regions C is selected to a point in time at which the state is turned in where any one position on the inside of the category regions C is not selected.

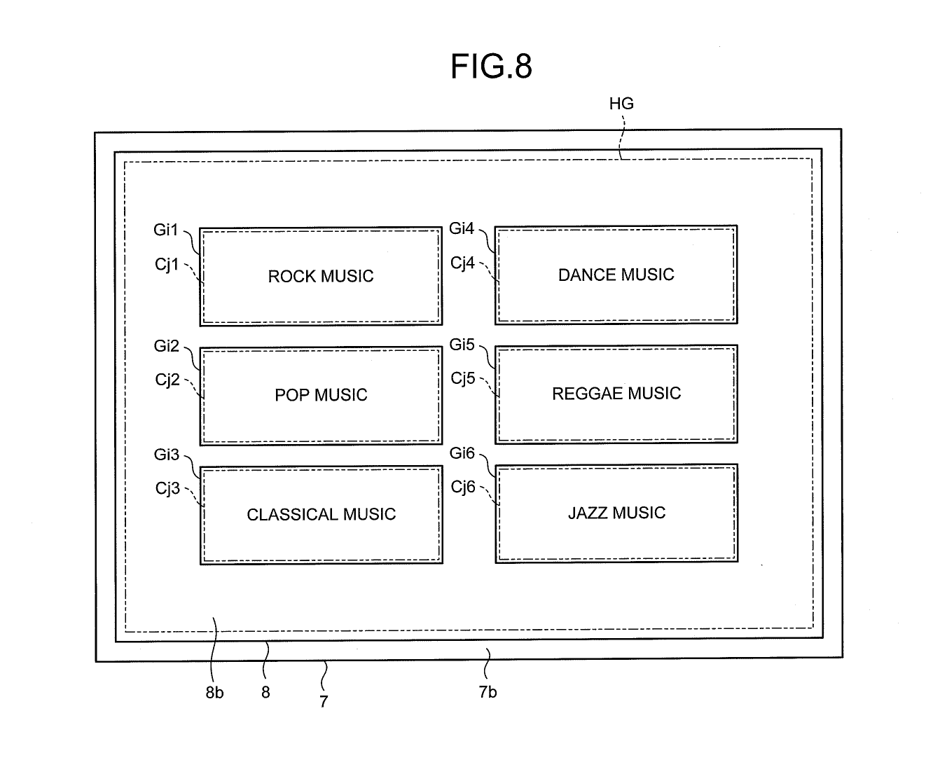

It is noted that the selection time period may be a time period in which the user starts the selection of any one position on the inside of the display screen HG and ends the selection. Also in this configuration, the effect of the embodiment can be exerted. In this case, a predetermined range in the inside of the foregoing display screen HG means the entire display screen HG. The selection time period means a time period from a point in time at which any one position on the inside of the display screen HG is selected to a point in time at which the state is turned in where any one position on the inside of the display screen HG is not selected. Moreover, the selection time period may be a time period in which the selection of any one position on the inside of the category regions C is started and the state is turned in where any one position on the inside of the display screen HG is not selected. In this case, a predetermined range in the inside of the foregoing display screen HG means the inside of the category regions C before the selection of any one position on the inside of the category regions C is started, whereas a predetermined range means the entire display screen HG after the selection of any one position on the inside of the category regions C is started. For example, as illustrated in FIG. 8, in a case where GUI images Gi1 to Gi6 are separated from each other, and category regions Cj1 to Cj6 corresponding to the GUI images Gi1 to Gi6 are also separated from each other; preferably, the selection time period is a time period in which the user starts the selection of any one position on the inside of the display screen HG and finishes the selection (the manipulation is interrupted), or a time period in where the selection of any one position on the inside of the category regions C is started and the state is turned in where any one position on the inside of the display screen HG is not selected. Furthermore, the selection time period may be a time period from a point in time at which the selection of any one position on the inside of the display screen HG is started to a point in time at which the state is turned in where the selected position is moved into the category regions C and then any one position on the inside of the category regions C is not selected. In this case, a predetermined range in the inside of the foregoing display screen HG means the entire display screen HG before the selection of any one position on the inside of the display screen HG is started, whereas a predetermined range means the inside of the category regions C after the selection of any one position on the inside of the display screen HG is started.

In the following, the detail of the content selection method by the controller 1 will be described using an example where a select manipulation input of the track K1 is made, as illustrated in FIG. 3. It is noted that in the example of the track K1, the track K1 passes through five category regions C: a category region Ca indicating a tune Crazy, a category region Cb indicating a tune Vivid, a category region Cc indicating a tune Orthodox, a category region Cd indicating a tune Dynamic, and a category region Ce indicating a tune Relax, during a state in which the select manipulation input is kept input.

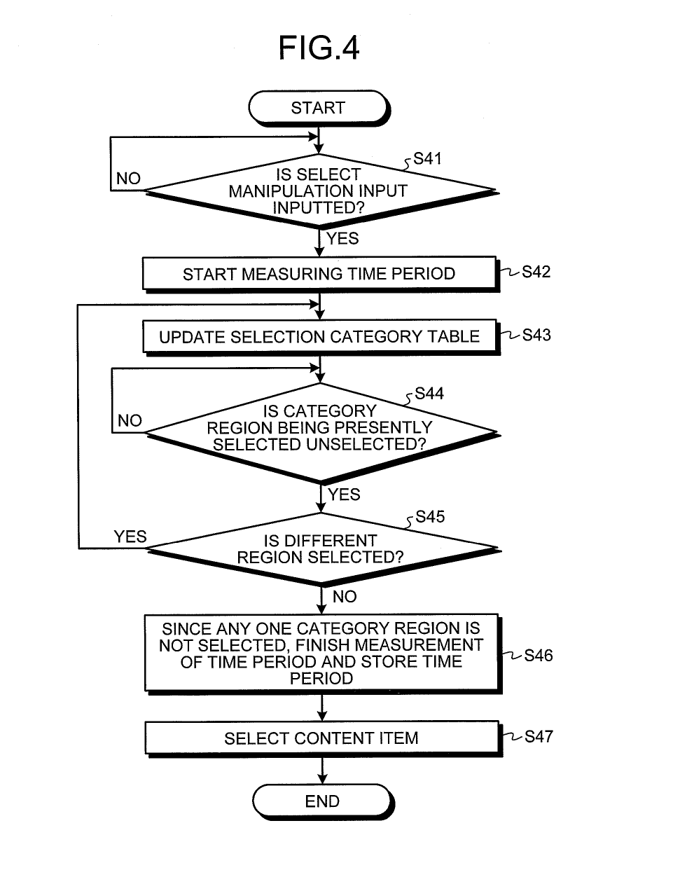

As illustrated in a flowchart in FIG. 4, when the power supply of the content selection apparatus 100 is turned on, or when the mode is turned to a content selecting mode by a predetermined manipulation input, a selected region identifying unit 102 identifies a region selected by a select manipulation input based on a manipulation input signal that is a signal in response to the manipulation input (in Step S41). It is noted that the manipulation input signal is input from the manipulation input unit 8.

The select determining unit 101 then determines whether the select manipulation input is input. In the embodiment, the select manipulation input means a manipulation input that selects any one position on the inside of the category regions C as described above. Thus, the select determining unit 101 determines whether the select manipulation input is input by determining whether the region identified at the selected region identifying unit 102 is the category regions C. As described above, the select determining unit 101 and the selected region identifying unit 102 function as a position detecting unit 107 that detects a position in response to a manipulation input.

In a case where a touch panel is used for the manipulation input unit 8, a select manipulation input is input when the pointing device is contacted or brought close to a position corresponding to the inside of any one of the category regions C on the touch panel, and the select determining unit 101 is detecting a voltage change or the like caused by the contact or closeness. In a case where a remote controller is used for the manipulation input unit 8, a select manipulation input is input when the button on the remote controller is pressed down in a state in which the instruction image SG is displayed on the inside of any one of the category regions C. In a case where a mouse is used for the manipulation input unit 8, a select manipulation input is input when the mouse is clicked in the state in which the instruction image SG is displayed on the inside of any one of the category regions C. It is noted that in a case where “the selection time period” is set to a time period in which the user starts the selection of any one position on the inside of the display screen HG and ends the selection, the select determining unit 101 may determine whether a select manipulation input is input by simply determining the presence or absence of a manipulation input signal.

When the select determining unit 101 determines that the select manipulation input is input (Yes in Step S41), the time measuring unit 103 starts measuring a time period (in Step S42). In the example of the track K1 illustrated in FIG. 3, the measurement of a time period is started from a point in time at which the selected position reaches a point SP2. On the other hand, in a case where a select manipulation input is not input (No in Step S41), operation of Step S41 is repeated. In the embodiment, during a period in which a position between the starting point SP1 and the point SP2 is selected, Step S41 is repeated.

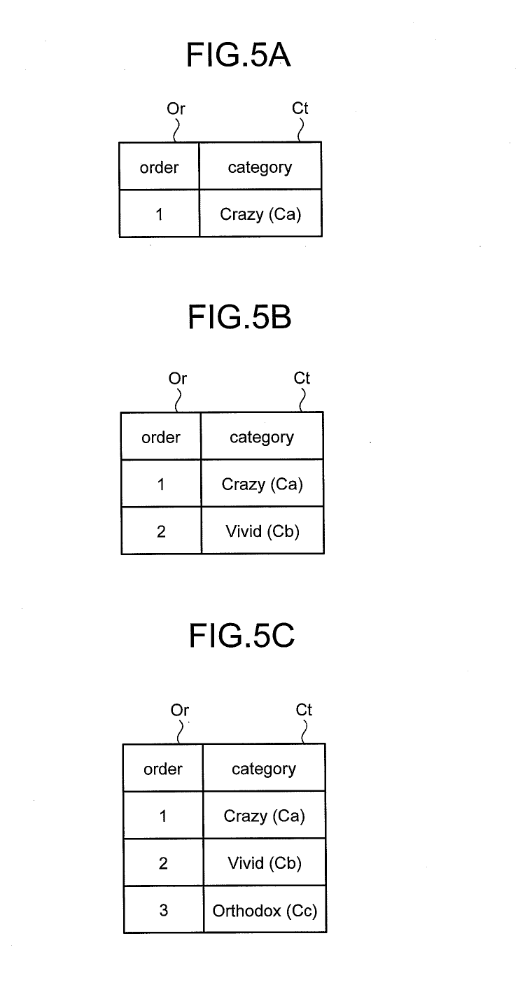

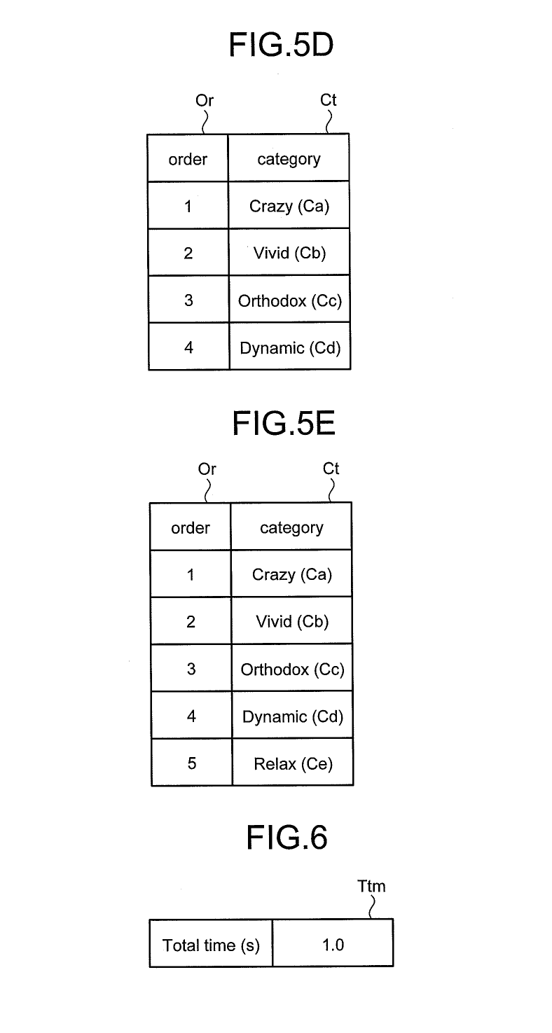

A storage control unit 104 updates a selection category table illustrated in FIGS. 5A to 5E (in Step S43). In other words, selected category information Ct indicating the selected category region that is a category region selected by the select manipulation input is stored on a storage unit 9. For example, when the track K1 of the select manipulation input reaches the point SP2, the category region Ca is selected. Thus, the storage control unit 104 stores selected category information Ct indicating the category region Ca on the storage unit 9.

Here, the selection category table will be described with reference to FIG. 5A. The selection category table is a table in which selected category information Ct indicating the selected category region is associated with a selected order Or. In the example illustrated in FIG. 3, since a plurality of category regions is selected by a single select manipulation input (a select manipulation input by the track K1) as in the state in which the select manipulation input is being input, the selected order is stored. At a point in time at which the selected position reaches the point SP2, the category “Crazy (Ca)” that is selected category information Ct indicating the category region Ca is stored together with the selected order “1” of the category “Crazy (Ca)”. It is noted that expressions such as “Crazy (Ca)” and “1” are expressions for easy understanding, and given identifiers may be used.

The selected region identifying unit 102 determines whether the category region being presently selected comes to be unselected (in Step S44). In a case where the category region being presently selected comes to be unselected (Yes in Step S44), the select determining unit 101 determines whether a different region is selected other than the category region that has been selected (in Step S45). On the other hand, in a case where the category region being presently selected is not unselected (No in Step S44), Step S44 is repeated. In a case where a different region is selected (Yes in Step S45), selection is moved from the region having been selected to the different region. In this case, the process is returned to Step S43, and the storage control unit 104 stores selected category information Ct indicating the category region at the moved position and the order Or that the category is selected on the storage unit 9.

For example, when the region being selected is moved from the category region Ca to the category region Cb, the category “Vivid (Cb)” that is selected category information Ct indicating the category region Cb is stored together with the selected order Or “2” of the category region Cb, as illustrated in FIG. 5B.

In the example of the track K1 illustrated in FIG. 3, during a period in which the position is between the point SP2 and the point EP2, processes from Step S43 to S45 are repeated. In other words, when the selected position is moved from the category region Cb to the category region Cc, the category “Orthodox (Cc)” that is selected category information Ct indicating the category region Cc is added to the selection category table together with the selected order Or “3” of the category “Orthodox (Cc)”, as illustrated in FIG. 5C. When the selected position is moved from the category region Cc to the category region Cd, the category “Dynamic (Cd)” that is selected category information Ct indicating the category region Cd is added to the selection category table together with the selected order Or “4” of the category “Dynamic (Cd)”, as illustrated in FIG. 5D. When the selected position is moved from the category region Cd to the category region Ce, the category “Relax (Ce)” that is selected category information Ct indicating the category region Ce is added to the selection category table together with the selected order Or “5” of the category “Relax (Ce)”, as illustrated in FIG. 5E.

On the other hand, in a case where a different region is not to be selected other than the category region that has been selected (No in Step S45), any one category region is not selected. Therefore, the select determining unit 101 determines that no select manipulation input has been input (in Step S46), and the time measuring unit 103 finishes the measurement of a time period based on the determination. The storage control unit 104 then stores a selection time period Ttm measured at the time measuring unit 103 on the storage control unit 104. In the embodiment, the selection time period Ttm is a time period in which the select manipulation input is started from the point SP2 and reaches the point EP2. In the embodiment, as illustrated in FIG. 6, a selection time period Ttm of “1.0 s” is stored. It is noted that an expression such as “1.0 s” is an expression for easy understanding, and a given identifier indicating being 1.0 second may be used.

Then the content selecting unit 105 selects a predetermined content item from a plurality of content items based on the selected category information Ct, the selected order Or, and the selection time period Ttm (in Step S47).

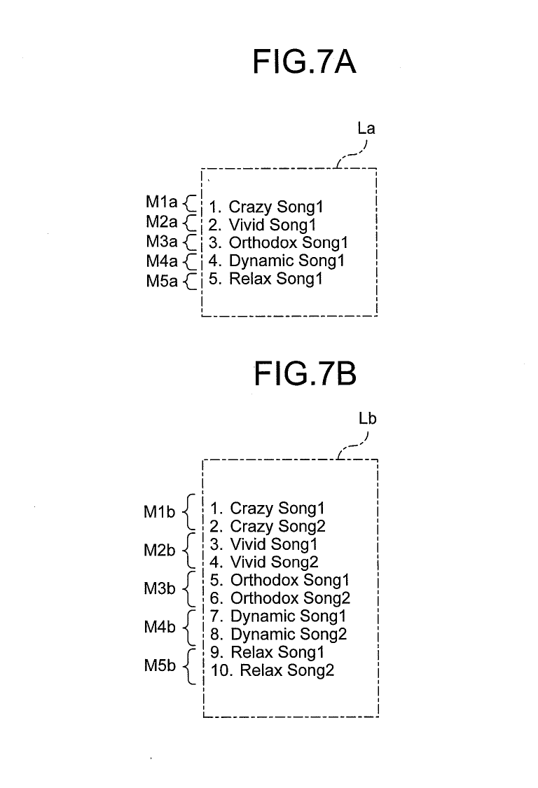

Here, the detail of the content selection method according to the embodiment will be described with reference to FIGS. 7A and 7B illustrating content items selected at the content selecting unit 105. The content selecting unit 105 selects more content items as the selection time period Ttm becomes longer. As illustrated in FIG. 7A, in a case where the selection time period Ttm is 1.0 s, the content selecting unit 105 selects a content group La formed of five content items, for example. Moreover, as illustrated in FIG. 7B, in a case where the selection time period Ttm is 2.0 s, the content selecting unit 105 selects a content group Lb formed of ten content items, for example. It is noted that the number of content items proportional to the selection time period Ttm may be selected, or the number of content items not proportional to the selection time period Ttm may be selected.

Furthermore, the content selecting unit 105 selects a content item belonging to the category indicated by selected category information Ct. In the example of the selection category table illustrated in FIG. 5E, the content selecting unit 105 individually selects a content item belonging to five categories, the categories “Crazy”, “Vivid”, “Orthodox”, “Dynamic”, and “Relax” indicated by selected category information Ct. In FIG. 7A, the content selecting unit 105 selects a content item M1a belonging to the category “Crazy”, a content item M2a belonging to the category “Vivid”, a content item M3a belonging to the category “Orthodox”, a content item M4a belonging to the category “Dynamic”, and a content item M5a belonging to the category “Relax”. In FIG. 7B, the content selecting unit 105 selects two content items M1b belonging to the category “Crazy”, two content items M2b belonging to the category “Vivid”, two content items M3b belonging to the category “Orthodox”, two content items M4b belonging to the category “Dynamic”, and two content items M5b belonging to the category “Relax”.

In addition, in a case where a content group whose order is established is selected like a playlist, the content selecting unit 105 makes reference to the order Or of the selection category table, and selects content items in the order based on the order Or. As illustrated in FIGS. 7A and 7B, the content selecting unit 105 selects content items in the order of the categories “Crazy”, “Vivid”, “Orthodox”, “Dynamic”, and “Relax”, which is the order based on the order Or. As described above, the order is established and content items are selected, so that the user can reproduce these content items in the order. It is noted that in a case where content items are not arranged by a playlist, for example, content items are not necessarily selected based on the order Or. In this case, such a configuration may be possible in which the order Or is not stored. The detail of the content selection method according to the embodiment is described above.

As described above, the user simply makes a manipulation input like the track K1 so that the user can select categories that the user desires to select and a rough number of content items. Accordingly, content items that the intent is considered can be selected from a large number of content items with simple manipulations.

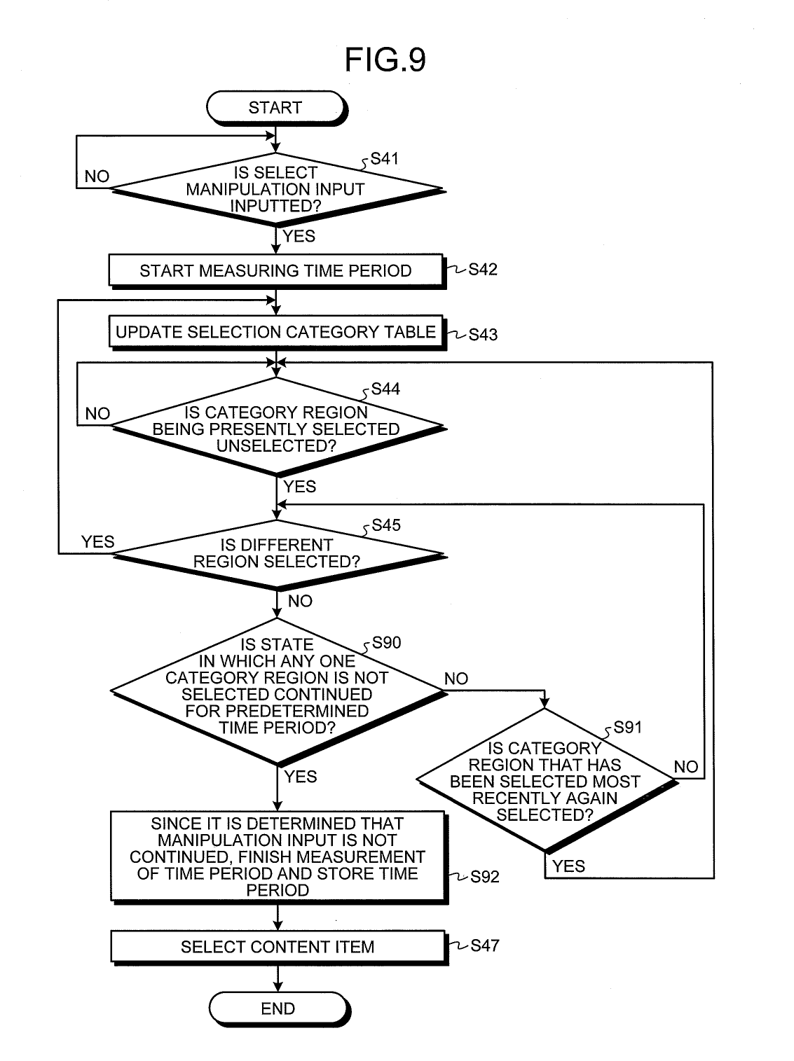

A content selection method according to a second embodiment will be described with reference to a flowchart in FIG. 9. It is noted that steps other than Steps S90 to S92 in the flowchart in FIG. 9 are similar to the steps in the first embodiment. Thus, the description is omitted other than the description in Steps S90 to S92.

In a case where a different region is not selected other than the category region that has been selected (No in Step S45), any one category region is not selected. In the embodiment, even though the selection is turned into the state in which any one category region is not selected, the content item is not selected immediately. In a case where the state in which any one category region is not selected is continued for a predetermined time period or more (Yes in Step S90), it is determined that a select manipulation is finished, and a content item is selected, or is decided to be selected. In the following, the embodiment will be described more in detail.

In a case where a different region is not selected other than the category region that has been selected (No in Step S45), a select determining unit 101 determines whether the state, in which any one category region is not selected, is continued for a predetermined time period or more (in Step S90). The predetermined time period is about 0.5 second, for example. However, the predetermined time period is not limited thereto. Moreover, the predetermined time period is measured at a time measuring unit 103.

In a case where the state, in which any one category region is not selected, is continued for a predetermined time period or more (No in Step S90), the select determining unit 101 determines whether the category region that has been selected most recently is again selected (in Step S91). In a case where the category region that has been selected most recently is again selected (Yes in Step S91), the process is returned to Step S44. In a case where the category region that has been selected most recently is not again selected (No in Step S91), the process is returned to Step S45, and the select determining unit 101 determines whether a different category region is selected other than the category region that has been selected most recently.

On the other hand, in a case where the state, in which any one category region is not selected, is continued for a predetermined time period or more (Yes in Step S90), the select determining unit 101 determines that the select manipulation input is finished (in Step S92), and the time measuring unit 103 finishes the measurement of the selection time period Ttm because of the determination.

The content selecting unit 105 then selects a predetermined content item from a plurality of content items based on the selected category information Ct, the selected order Or, and the selection time period Ttm (in Step S47).

In a case where the state, in which any one category region is not selected, is continued for a predetermined time period or more (No in Step S90), loops included in Steps S43, S44, S45, S90, and S91 are repeated.

The content selection method according to the embodiment is described above. In accordance with the content selection method according to the embodiment, in a case where the state, in which any one category region is not selected, is not continued for a predetermined time period or more even though the user unintentionally discontinues a select manipulation input, it is determined that the select manipulation input is continued. Thus, operability is more improved. In other words, the selection time period in the embodiment is a time period from a point in time at which any one position on the inside of the plurality of category regions C is selected to a point in time at which the state, in which any one category region is not selected, is continued for a predetermined time period or more. It is noted that a time period from a point in time at which any one position on the inside of the display screen HG is selected to a point in time at which the state, in which any one position on the inside of the display screen HG is not selected, is continued for a predetermined time period or more may be set to the selection time period. Moreover, a time period from a point in time at which any one position on the inside of the plurality of category regions C is selected to a point in time at which the state in which any one position on the inside of the display screen HG is not selected is continued for a predetermined time period or more may be set to the selection time period. This configuration is particularly effective when the category regions are apart from each other as illustrated in FIG. 8. Furthermore, a time period from a point in time at which the selection of any one position on the inside of the display screen HG is started to a point in time at which the selected position is moved into the category regions C; and then the state, in which any one position on the inside of the category regions C is not selected, is continued for a predetermined time period or more may be set to the selection time period.

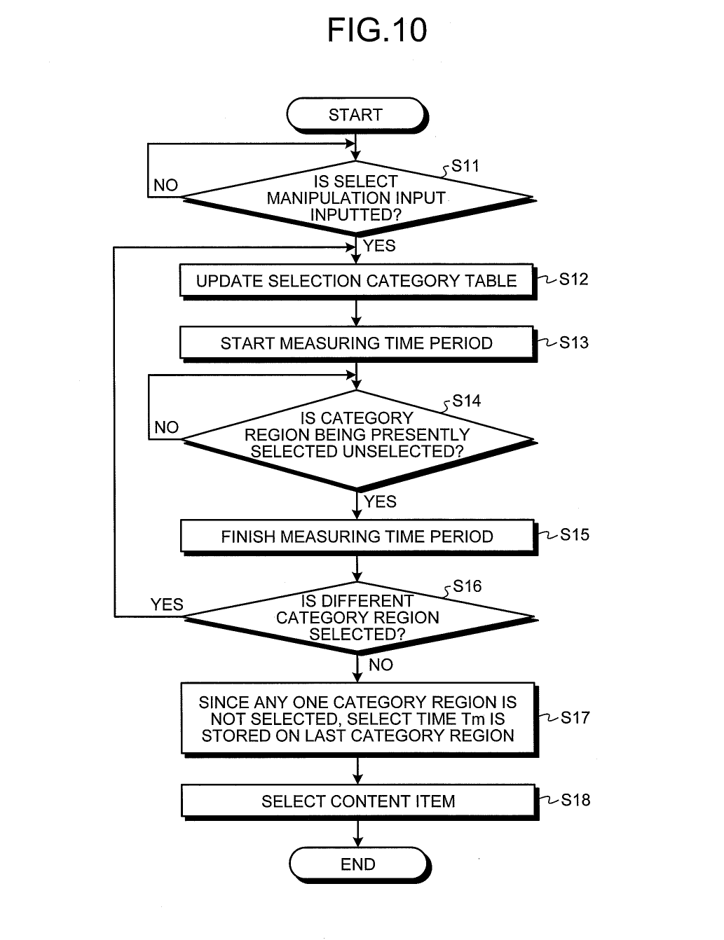

A content selection method according to a third embodiment will be described with reference to FIGS. 10 to 12B. It is noted that the configurations other than the content selection method are similar to the configurations of the other embodiments. Thus, the description of the configurations other than the content selection method is omitted. The content selection method according to the third embodiment is different from the content selection methods according to the first and second embodiments in information on the selection category table. The selection time period Tm is particularly different. Moreover, since information on the selection category table is different, a method for selecting a content item is different as well.

First, as illustrated in a flowchart in FIG. 10, when the power supply of a content selection apparatus 100 is turned on, or when the mode is turned to a content selecting mode by a predetermined manipulation input, a selected region identifying unit 102 identifies a region selected by a select manipulation input based on a manipulation input signal that is a signal in response to the manipulation input (in Step S11). It is noted that the manipulation input signal is input from a manipulation input unit 8.

A select determining unit 101 then determines whether the select manipulation input is input. In the embodiment, the select manipulation input means a manipulation input to select any one position on the inside of the category regions C, for example. Thus, the select determining unit 101 determines whether the select manipulation input is input by determining whether the region identified at the selected region identifying unit 102 is the category regions C.

In a case where the select determining unit 101 determines that a select manipulation input is input (Yes in Step S11), a storage control unit 104 updates a selection category table (Step S12). In other words, the storage control unit 104 stores selected category information Ct indicating a category region selected by the select manipulation input on a storage unit 9. For example, when the track K1 of the select manipulation input reaches the point SP2 as illustrated in FIG. 3, the category region Ca is selected. Thus, the storage control unit 104 stores the selected category information Ct indicating the category region Ca on the storage unit 9 together with the selected order Or of the category region Ca.

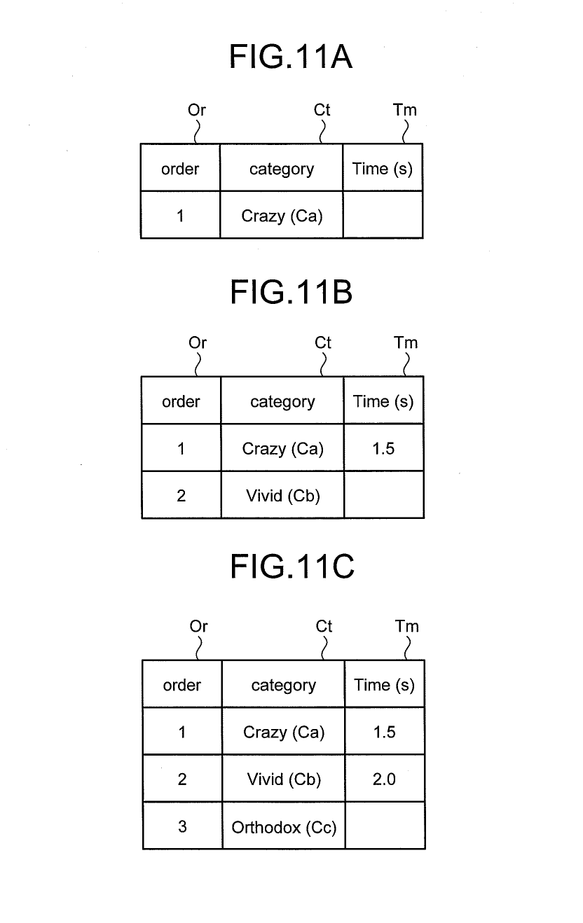

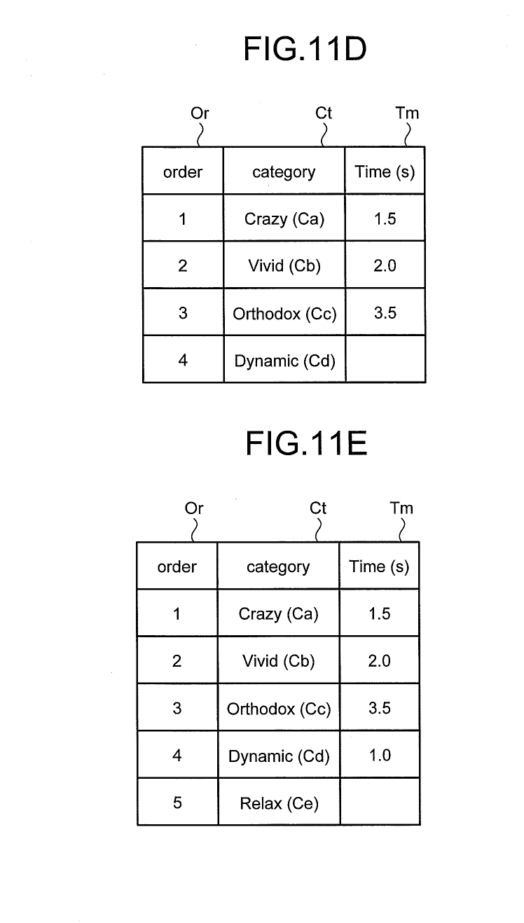

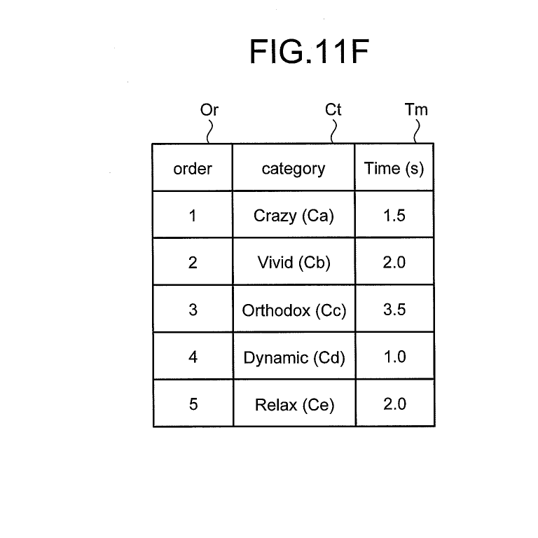

Here, the selection category table according to the embodiment will be described with reference to FIGS. 11A to 11F. The selection category table according to the embodiment is a table in which selected category information Ct indicating the selected category region, the selected order Or, and the selection time period Tm that is a time period in which category regions are individually selected are associated with each other. At a point in time at which the track K1 reaches the point SP2, the category “Crazy (Ca)” that is selected category information Ct indicating the category region Ca is stored together with the selected order “1” of the category “Crazy (Ca)”, as illustrated in FIG. 11A. At this point in time, the selection time period Tm related to the category region Ca is not stored yet.

Now again referring to the flowchart in FIG. 10, in a case where a select manipulation input is not input (No in Step S11), Step S11 is repeated. In the example of the track K1 illustrated in FIG. 3, during a period in which a position between the starting point SP1 and the point SP2 is selected, Step S11 is repeated.

A time measuring unit 103 starts measuring a time period (Step S13). In the example of the track K1 illustrated in FIG. 3, the measurement of a time period is started from a point in time at which the selected position reaches a point SP2.

The selected region identifying unit 102 determines whether the category region being presently selected is unselected (Step S14). In a case where the category region being presently selected is unselected (Yes in Step S14), the time measuring unit 103 finishes measuring a time period (Step S15), and the process goes to Step S16. On the other hand, in a case where the category region being presently selected is not unselected (No in Step S14), Step S14 is repeated. The select determining unit 101 determines whether a different region is selected other than the category region that has been selected (Step S16).

In a case where a different region is selected (Yes in Step S16), selection is moved from the region having been selected to the different region. In this case, the process is returned to Step S12. When the process is returned to Step S12, as illustrated in FIG. 11B, the storage control unit 104 stores the category “Vivid (Cb)” that is selected category information Ct indicating the category region at the moved position is stored together with the selected order Or “2” of the category “Vivid (Cb)”. Moreover, as illustrated in FIG. 11B, the selection time period Tm indicating a time period is also stored, in which the selection of the category region Ca is started and the category region Ca is unselected. The time period stored at this time is a time period in which the category region Ca has been selected, which is “1.5 s”, for example.

In the example of the track K1 illustrated in FIG. 3, during a period in which the position is between the point SP2 and the point EP2, Steps S12 to S16 are repeated. For example, when the selected position is moved from the category region Cb to the category region Cc, the category “Orthodox (Cc)” that is selected category information Ct indicating the category region Cc is added to the selection category table together with the selected order Or “3” of the category “Orthodox (Cc)”, as illustrated in FIG. 11C. Moreover, as illustrated in FIG. 11C, the selection time period Tm indicating a time period in which the selection of the category region Cb is started and the category region Cb is unselected is also stored. The time period stored at this time is a time period in which the category region Cb has been selected, which is “2.0 s”, for example.

Furthermore, when the selected position is moved from the category region Cc to the category region Cd, the category “Dynamic (Cd)” that is selected category information Ct indicating the category region Cd is added to the selection category table together with the selected order Or “4” of the category “Dynamic (Cd)”, as illustrated in FIG. 11D. In addition, as illustrated in FIG. 11D, the selection time period Tm indicating a time period in which the selection of the category region Cc is started and the category region Cc is unselected is also stored. The time period stored at this time is a time period in which the category region Cc has been selected, which is “3.5 s”, for example. Moreover, when the selected position is moved from the category region Cd to the category region Ce, the category “Relax (Ce)” that is selected category information Ct indicating the category region Ce is added to the selection category table together with the selected order Or “5” of the category “Relax (Ce)”, as illustrated in FIG. 11E. Furthermore, as illustrated in FIG. 11E, the selection time period Tm indicating a time period in which the selection of the category region Cd is started and the category region Cd is unselected is also stored. The time period stored at this time is a time period in which the category region Cd has been selected, which is “1.0 s”, for example.

On the other hand, in a case where a different region is not selected other than the category region that has been selected (No in Step S16), any one of the category regions C is not selected, and the select determining unit 101 determines that no select manipulation input is input (in Step S17). The storage control unit 104 stores the selection time period Tm in which the latest selected category region Ce has been selected because of the determination.

In the example of the track K1 illustrated in FIG. 3, when the select manipulation input reaches the point EP2, as illustrated in FIG. 11F, the storage control unit 104 stores the selection time period Tm indicating a time period in which the selection of the category region Ce is started and any one category region is not selected (a time period until the category region Ce is unselected). The time period stored at this time is a time period in which the latest selected category region Ce has been selected, which is “2.0 s”, for example. It is noted that in a case where the same category region C is selected for several times, the selection time period Tm may be added. Moreover, an expression such as “1.0 s” used in the description above is an expression for easy understanding, and a given identifier indicating being 1.0 second may be used, for example.

A content selecting unit 105 selects a predetermined content item from a plurality of content items based on the items of selected category information Ct, the selected orders Or, and the selection time periods Tm (Step S18).

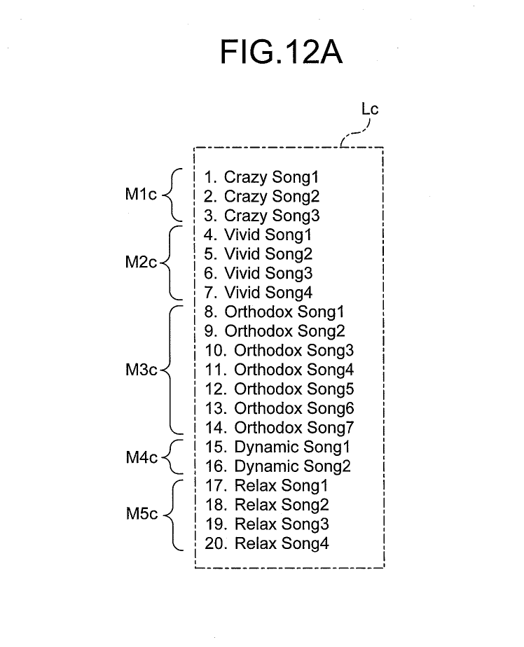

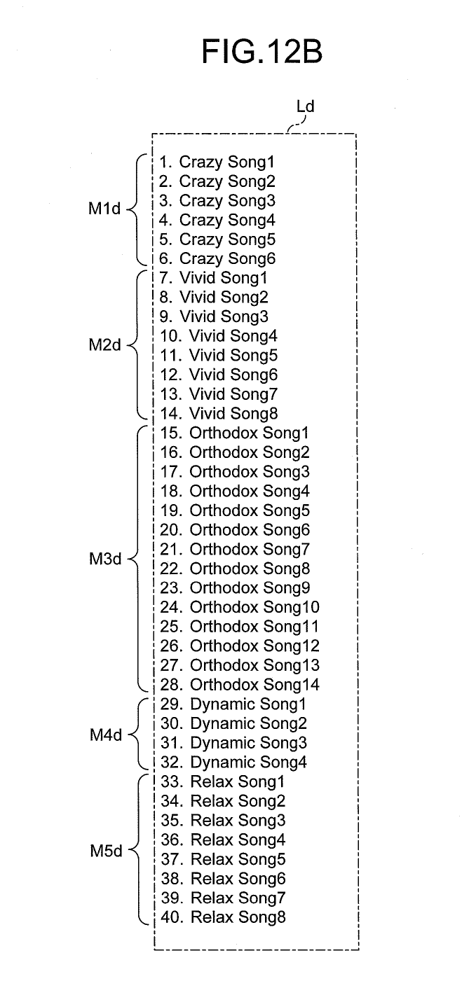

Here, the detail of the content selection method according to the embodiment will be described with reference to FIG. 12A illustrating a content item group Lc formed of content items selected at the content selecting unit 105. The content selecting unit 105 selects more content items belonging to the category whose selection time period Tm is longer. In the example illustrated in FIG. 12A, the content selecting unit 105 selects a content item per selection time period Tm of 0.5 second.

More specifically, since the selection time period Tm for the category Crazy (Ca) is 1.5 seconds, the content selecting unit 105 selects three content items M1c belonging to the category Crazy (Ca). In the following, similarly, the content selecting unit 105 selects four content items M2c belonging to the category Vivid (Cb) because the selection time period Tm for the category Vivid (Cb) is 2.0 seconds. The content selecting unit 105 selects seven content items M3c belonging to the category Orthodox (Cc) because the selection time period Tm for the category Orthodox (Cc) is 3.5 seconds. The content selecting unit 105 selects two content items M4c belonging to the category Dynamic (Cd) because the selection time period Tm for the category Dynamic (Cd) is 1.0 second. The content selecting unit 105 selects four content items M5c belonging to the category Relax (Ce) because the selection time period Tm for the category Relax (Ce) is 2.0 seconds. It is noted that in the example illustrated in FIG. 12A, the number of content items proportional to the selection time period Tm may be selected, or the number of content items not proportional to the selection time period Tm may be selected.

Next, another exemplary content selection method will be described with reference to FIG. 12B illustrating a content item group Ld formed of content items selected at the content selecting unit 105. This content selection method is the same as the content selection methods described above in that content items are selected in such a way that content items belonging to the category whose selection time period Tm is longer are more selected. However, in this example, content items are selected based on the ratios of the selection time periods Tm for the individual categories to the total time period that the selection time periods Tm for all the categories are added together. This method is effective in a case where the total number of content items to be selected is predetermined, for example.

In the example illustrated in FIG. 12B, the total number of content items to be selected is predetermined as 40 items. The number 40 is determined as specified by the user, for example.

First, the content selecting unit 105 calculates the total time period that the selection time periods Tm for all the categories are added together. In the example illustrated in FIG. 11F, the total time period is 1.5+2.0+3.5+1.0+2.0=10.0 seconds. The total time period may be calculated by computation, or found by measurement at the time measuring unit 103.

Subsequently, the content selecting unit 105 individually calculates the ratios of the selection time periods Tm to the total time period. The ratio of the selection time period Tm for the category Crazy (Ca) to the total time period is 1.5/10.0. Similarly, the ratio of the selection time period Tm for the category Vivid (Cb) to the total time period is 2.0/10.0. The ratio of the selection time period Tm for the category Orthodox (Cc) to the total time period is 3.5/10.0. The ratio of the selection time period Tm for the category Dynamic (Cd) to the total time period is 1.0/10.0. The ratio of the selection time period Tm for the category Relax (Ce) to the total time period is 2.0/10.0. The content selecting unit 105 calculates these ratios.

Subsequently, the content selecting unit 105 calculates the number of content items to be selected on the individual categories by multiplying the predetermined total number of content items by the calculated ratio. For example, in a case where the predetermined total number of content items is 40, the number of content items to be selected on the category Crazy (Ca) is 40×(1.5/10.0)=6 because the ratio of the category Crazy (Ca) is 1.5/10.0. Similarly, the number of content items to be selected on the category Vivid (Cb) is 40×(2.0/10.0)=8 because the ratio of the category Vivid (Cb) is 2.0/10.0. The number of content items to be selected on the category Orthodox (Cc) is 40×(3.5/10.0)=14 because the ratio of the category Orthodox (Cc) is 3.5/10.0. The number of content items to be selected on the category Dynamic (Cd) is 40×(1.0/10.0)=4 because the ratio of the category Dynamic (Cd) is 1.0/10.0. The number of content items to be selected on the category Relax (Ce) is 40×(2.0/10.0)=8 because the ratio of the category Relax (Ce) is 2.0/10.0.

The content selecting unit 105 then selects the content item group Ld by selecting the calculated number of content items belonging to the individual categories. More specifically, as illustrated in FIG. 12B, since the number of content items on the category Crazy (Ca) is six, the content selecting unit 105 selects six content items Mid belonging to the category Crazy (Ca). In the following, similarly, the content selecting unit 105 selects eight content items M2d belonging to the category Vivid (Cb), 14 content items M3d belonging to the category Orthodox (Cc), four content items M4d belonging to the category Dynamic (Cd), and eight content items M5d belonging to the category Relax (Ce).

Content items are selected as in the example, and a predetermined number of content items can be selected. It is noted that when the number of content items is not divided in calculating the ratio, the number is round off, the number is rounded down, or the number is rounded up for obtaining a natural number. Moreover, the number of content items may be adjusted so as to obtain a predetermined number of content items.

As described above, the user can select categories that the user desires to select and a rough number of content items on the individual categories by slowly moving the finger on the category region that the user desires to select more content items. Accordingly, content items that the intent is considered can be selected from a large number of content items with simple manipulations. Moreover, in a case where the state in which any one category region is not selected is continued for a predetermined time period or more as in the second embodiment, it may be determined that the select manipulation input is continued.

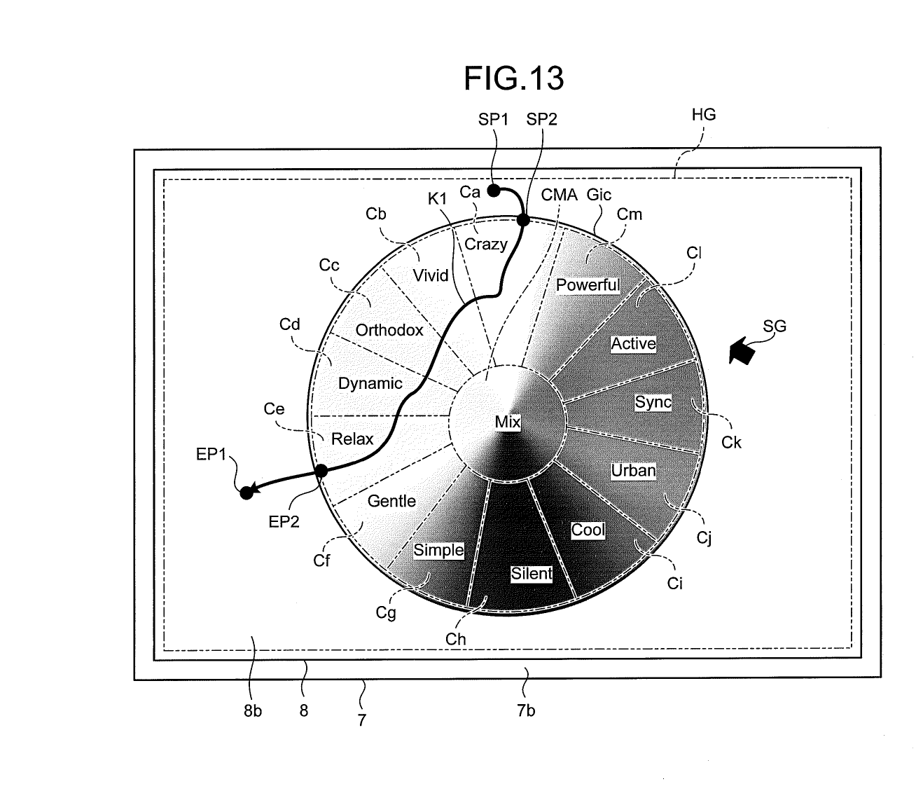

A GUI image Gic according to a fourth embodiment will be described with reference to FIG. 13. It is noted that the GUI image Gic can be used in combination with the content selection methods according to the other embodiments.

The GUI image Gic according to the embodiment is different from the GUI image Gi according to the other embodiments in that such a GUI image Gic is provided in which hues are gradually changed toward the circumferential direction of a circular shape. In a case where similar category regions are disposed adjacently as category regions are in closer distances in the circumferential direction, as illustrated in FIG. 13, the GUI image Gic in which hues are gradually changed is used, and changes in impression caused by hues can be associated with changes in the impression of categories (tunes, for example). As described above, when the impression of the categories is expressed by colors, the expressions of the categories Crazy, Vivid, and so on may not be displayed. Moreover, more preferably, when such a GUI image Gic is provided in which the GUI image Gic is in a circular shape and hues are gradually changed toward the circumferential direction of a circular shape, content items can be easily selected by a single manipulation input like the track K1.

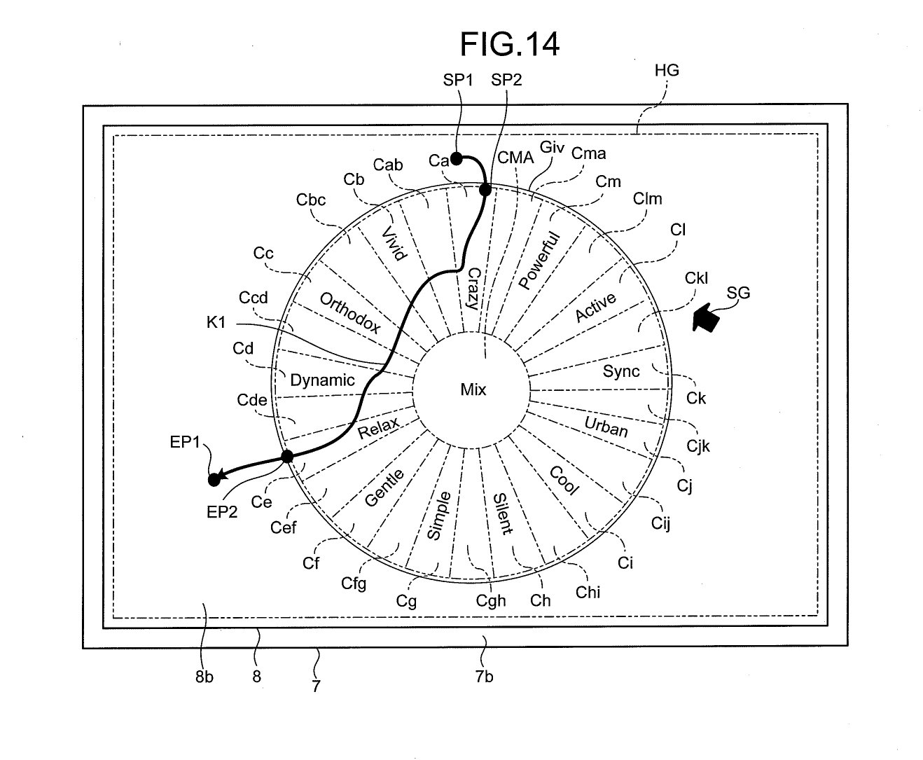

A GUI image Giv and a content selection method according to a fifth embodiment will be described with reference to FIGS. 14 to 16. It is noted that only portions different from the portions of the other embodiments are described, and the description of the configurations common in the configurations of the other embodiments is omitted.

First, the GUI image Giv according to the embodiment will be described with reference to FIG. 14. As depicted by long dashed double-short dashed lines in FIG. 14, the GUI image Giv is sectioned in a plurality of category regions C (Ca, Cab, and Cb, to Cm, Cma, and CMA). The category regions C are allocated with a single category or a plurality of categories (two categories in the embodiment) to sort a plurality of content items recorded on a content recording unit 3.

More specifically, the category regions are disposed in such a way that the category region to which a single category is allocated and the category region to which two categories are allocated are alternately arranged in the circumferential direction of a circular shape. Moreover, the category region to which two categories are allocated is allocated with the categories allocated to the adjacent category regions. In FIG. 14, for example, the category region Cab is allocated with two categories, the category Crazy allocated to the preceding category region Ca and the category Vivid allocated to the following (subsequent) category region Cb.

In the following, similarly, the category regions to which two category regions are allocated will be described in counterclockwise order. The category region Cbc is allocated with two categories, the category Vivid allocated to the category region Cb and the category Orthodox allocated to the category region Cc. Moreover, the category region Ccd is allocated with two categories, the category Orthodox allocated to the category region Cc and the category Dynamic allocated to the category region Cd. Furthermore, the category region Cde is allocated with two categories, the category Dynamic allocated to the category region Cd and the category Relax allocated to the category region Ce. In addition, the category region Cef is allocated with two categories, the category Relax allocated to the category region Ce and the category Gentle allocated to the category region Cf. Moreover, the category region Cfg is allocated with two categories, the category Gentle allocated to the category region Cf and the category Simple allocated to the category region Cg.

Furthermore, the category region Cgh is allocated with two categories, the category Simple allocated to the category region Cg and the category Silent allocated to the category region Ch. In addition, the category region Chi is allocated with two categories, the category Silent allocated to the category region Ch and the category Cool allocated to the category region Ci. Moreover, the category region Cij is allocated with two categories, the category Cool allocated to the category region Ci and the category Urban allocated to the category region Cj.

Furthermore, the category region Cjk is allocated with two categories, the category Urban allocated to the category region Cjk and the category Sync allocated to the category region Ck. In addition, the category region Ckl is allocated with two categories, the category Sync allocated to the category region Ck and the category Active allocated to the category region Cl. Moreover, the category region Clm is allocated with two categories, the category Active allocated to the category region Cl and the category Powerful allocated to the category region Cm. Furthermore, the category region Cma is allocated with two categories, the category Powerful allocated to the category region Cm and the category Crazy allocated to the category region Ca.

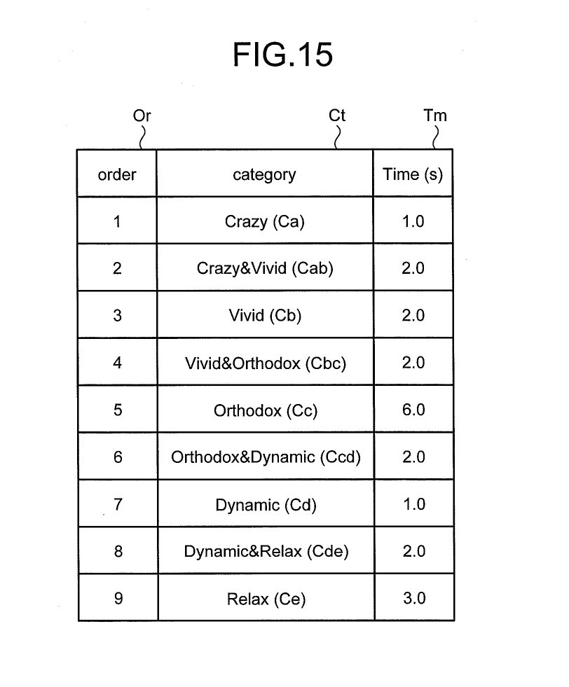

In addition, the category region CMA is allocated with all the categories Crazy, Vivid, Orthodox, Dynamic, Relax, Gentle, Simple, Silent, Cool, Urban, Sync, Active, and Powerful. It is noted that the category region CMA may not be necessarily provided. Moreover, the number of category regions allocated to the inside of the GUI image Giv is not limited to 13 types described above. FIG. 15 is a diagram of a selection category table according to the embodiment. As similar to the third embodiment, the selection category table according to the embodiment is a table in which selected category information Ct indicating the selected category region, the selected order Or, and the selection time period Tm that is a time period in which category regions are individually selected are associated with each other.

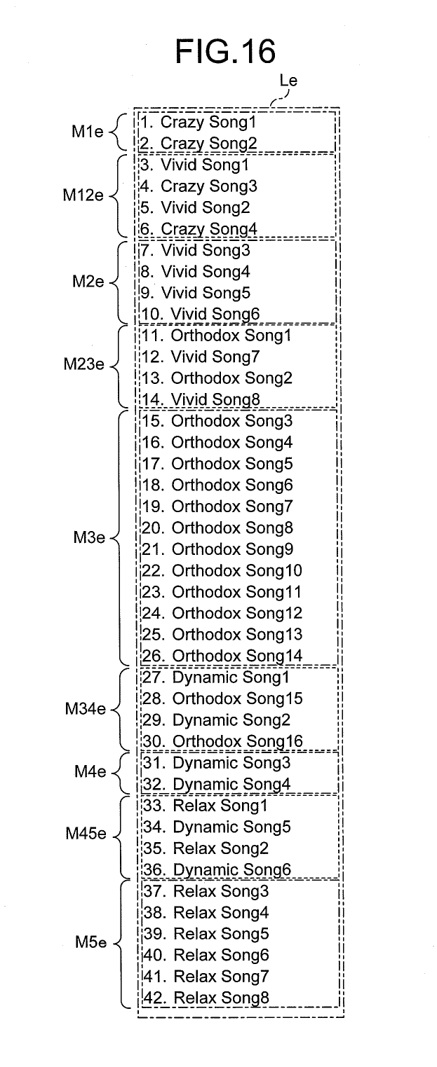

Next, the detail of the content selection method according to the embodiment will be described in a case where a manipulation input of a track K1 illustrated in FIG. 14 is input with reference to FIG. 16 illustrating content items selected at a content selecting unit 105. As in the third embodiment, an example will be described in which the content selecting unit 105 selects content items in such a way that content items belonging to the category whose selection time period Tm is longer are more selected. However, the content selection methods described in the other embodiments or the like can also be used. Since the embodiment is different from the other embodiments in the regions to which two categories are allocated, the difference will be mainly described. It is noted that for example, in FIG. 16, the content selecting unit 105 selects a single content item per selection time period Tm of 0.5 second for selecting a content item group Le.

As illustrated in FIG. 16, since the selection time period Tm for the category region Crazy and Vivid (Cab) to which two categories Crazy and Vivid are allocated is 2.0 seconds, the content selecting unit 105 selects four content items M12e belonging to the category Crazy or Vivid. At this time, preferably, the number of content items belonging to the category Crazy is made equal to the number of content items belonging to the category Vivid. However, it is fine that at least one content item is included. This is the same as in the description below.

In the following, similarly, since the selection time period Tm for the category region Vivid and Orthodox (Cbc) to which two categories Vivid and Orthodox are allocated is 2.0 seconds, the content selecting unit 105 selects four content items M23e belonging to the category Vivid or Orthodox. Since the selection time period Tm for the category region Orthodox and Dynamic (Ccd) to which two categories Orthodox and Dynamic are allocated is 2.0 seconds, the content selecting unit 105 selects four content items M34e belonging to the category Orthodox or Dynamic. Since the selection time period Tm for the category region Dynamic and Relax (Cde) to which two categories Dynamic and Relax are allocated is 2.0 seconds, the content selecting unit 105 selects four content items M45e belonging to the category Dynamic or Relax.

It is noted that preferably, the content items selected based on the category regions to which two categories are allocated are reproduced alternately. For example, in a case where four content items M12e belonging to the category Crazy or Vivid are selected, preferably, these content items are reproduced in order of a content item belonging to the category Crazy, a content item belonging to the category Vivid, a content item belonging to the category Crazy, and a content item belonging to the category Vivid. Of course, the content items may be reproduced in order of a content item belonging to the category Vivid, a content item belonging to the category Crazy, a content item belonging to the category Vivid, and a content item belonging to the category Crazy.

It is noted that for the other categories, the content selecting unit 105 selects two content items M1e belonging to the category Crazy (Ca) because the selection time period Tm for the category Crazy (Ca) is 1.0 second, four content items M2e belonging to the category Vivid (Cb) because the selection time period Tm for the category Vivid (Cb) is 2.0 seconds, 12 content items M3e belonging to the category Orthodox (Cc) because the selection time period Tm for the category region Orthodox (Cc) is 6.0 seconds, two content items M4e belonging to the category Dynamic (Cd) because the selection time period Tm for the category region Dynamic (Cd) is 1.0 second, and six content items M5e belonging to the category Relax (Ce) because the selection time period Tm for the category region Relax (Ce) is 3.0 seconds.

As described above, the category region to which a single category is allocated and the category region to which a plurality of category regions is allocated are alternately disposed, and the category region to which two category regions are allocated is allocated with the categories allocated to the adjacent category regions. Thus, a plurality of content items that user's intent is considered can be selected from a large number of content items with simple manipulations, and categories can be gently changed.

It is noted that preferably, the GUI image Giv is formed in a circular shape, and the category region to which a single category is allocated and the category region to which a plurality of category regions is allocated are alternately arranged in the circumferential direction of the circular shape, as in the embodiment. However, the configuration is not limited thereto. For example, such a configuration may be possible in which the category region to which a single category is allocated and the category region to which a plurality of category regions is allocated are linearly alternately arranged. Also in this case, the category region to which two category regions are allocated is allocated with the categories allocated to the adjacent category regions.

In the embodiment, the category region to which a single category is allocated and the category region to which a plurality of categories is allocated are alternately arranged, and the content item group Le is selected in order of a content item group (the content item group Mie, for example) in a first category, a content item group including a content item in the first category and a content item in a second category (the content item group M12e, for example), and a content item group in the second category (the content item group M2e, for example). However, such a configuration may be possible in which a content item group including a content item in a first category and a content item in a second category is selected according to a predetermined rule, not providing the category region to which a plurality of categories is allocated. For example, such configurations may be possible in which a content item group including a content item in a first category and a content item in a second category is selected by a predetermined number all the time, and in which a content item group including a content item in a first category and a content item in a second category is selected by the number corresponding to the number of content items in the first category and the number of content items in the second category. In the example illustrated in FIG. 16, the content item group including a content item in a first category and a content item in a second category is depicted by broken lines, and the other content item groups are depicted by long dashed single-short dashed lines.

It is noted that the present invention includes programs that cause a computer to execute the functions of the controller 1 according to the embodiments. These programs may be read out of a recording medium and installed on a computer, or may be transmitted via a communication network and installed on a computer.

Moreover, the present invention is not limited to the foregoing embodiments, and can be modified variously within a scope not deviating from the teachings of the present invention. For example, the embodiments may be combined. Furthermore, the present invention can be used for various devices such as a music content reproducing device, an image content reproducing device, a mobile telephone, a portable music player, a game machine, a navigation device, and a personal computer. In addition, the functions of the content selection apparatus may be implemented in which a part of the configuration of the content selection apparatus is formed separately and the content selection apparatus communicates with the separated device through a network or the like.

It is noted that music content and image content are taken as examples and described as content data. However, the present invention is also applicable to text content. For example, the present invention is also applicable to content items for a digital book, news information, and so on. Moreover, the present invention is also applicable to information content related to various articles, financial products, real estates, persons, and so on. In Addition, the present invention is also applicable to the recommendation of products to a user in electronic commerce or the like. In other words, the present invention is also applicable to information content related to commercial products. Furthermore, such a configuration may be possible in which the number of content items to be selected at the content selecting unit 105 is displayed in the midway point of inputting the select manipulation input or when the select manipulation input is finished, for example. With this display, convenience is more improved.

In accordance with the content selection apparatus, the content selection method, and the computer readable storage medium according to the embodiments, a plurality of content items that user's intent more reflects can be selected from a large number of content items with simple manipulations.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A content selection apparatus comprising:
a select determining unit configured to determine whether a select manipulation input is input,
the select manipulation input being a manipulation input to select a predetermined range on a display screen on which a GUI image including a plurality of category regions is displayed, and
the category region being a region to which a category or a plurality of categories is allocated to sort a content item;
a selected region identifying unit configured to identify a region corresponding to a position of the select manipulation input that is selected by the select manipulation input;
a time measuring unit configured to measure a selection time period that is a time period involved in the select manipulation input; and
a content selecting unit configured to select a number of content items based on the selection time period in accordance with selected category information indicating a selected category region that is a region identified by the selected region identifying unit.

2. The content selection apparatus according to claim 1, further comprising a storage control unit configured to store the selected category information together with an order of selection selected by the select manipulation input, wherein
the content selecting unit selects content items belonging to categories indicated by the selected category information based on the order.

3. The content selection apparatus according to claim 1, wherein the content selecting unit selects more content items of which selection time period is longer.

4. The content selection apparatus according to claim 1, wherein:
the selection time period is a time period in which each of the selected category regions is selected;
the apparatus further comprises
a storage control unit configured to store the selection time periods together with each of the selected category information; and
the content selecting unit selects more content items included in a selected category region of which selection time period is longer.

5. The content selection apparatus according to claim 4, wherein:
the content selecting unit calculates each ratio of each of the selection time periods to a total time period calculated by summing up each of the selection time period, and
the content selecting unit selects more content items included in a selected category region of which selection time period is longer based on a value acquired by multiplying a predetermined number with each of the ratios.

6. The content selection apparatus according to claim 1, wherein:
the predetermined range is all the display screen; and
the selection time period is a time period from a point in time at which any one position on the display screen is selected to a point in time at which any one position on the display screen is not selected.

7. The content selection apparatus according to claim 1, wherein:
the predetermined range is all the display screen; and
the selection time period is a time period from a point in time at which any one position on the display screen is selected to a point in time at which a state, in which any one position on the display screen is not selected, is continued for a predetermined time period or more.

8. The content selection apparatus according to claim 1, wherein:
the predetermined range is a plurality of the category regions; and
the selection time period is a time period from a point in time at which any one position on the plurality of the category regions is selected to a point in time at which a state is turned in where any one position on the plurality of the category regions is not selected.

9. The content selection apparatus according to claim 1, wherein:
the predetermined range is a plurality of the category regions; and
the selection time period is a time period from a point in time at which any one position on the plurality of the category regions is selected to a point in time at which a state, in which any one position on the plurality of the category regions is not selected, is continued for a predetermined time period or more.

10. The content selection apparatus according to claim 1, wherein the selection time period is a time period from a point in time at which any one position on a plurality of the category regions is selected to a point in time at which a state is turned in where any one position on the display screen is not selected.

11. The content selection apparatus according to claim 1, wherein the selection time period is a time period from a point in time at which any one position on a plurality of the category regions is selected to a point in time at which a state, in which any one position on the display screen is not selected, is continued for a predetermined time period or more.

12. The content selection apparatus according to claim 1, wherein the selection time period is a time period from a point in time at which any one position on the display screen is selected to a point in time at which a state is turned in where any one position on a plurality of the category regions is not selected after the selected position is moved at any another position on the plurality of the category regions.

13. The content selection apparatus according to claim 1, wherein the selection time period is a time period from a point in time at which any one position on the display screen is selected to a point in time at which a state, in which any one position on a plurality of the category regions is not selected, is continued for a predetermined time period or more after the selected position is moved at any another position on the plurality of the category regions.

14. The content selection apparatus according to claim 1, further comprising a GUI image generating unit configured to generate the GUI image that includes:
a first category region to which one category is allocated;
a second category region to which another category is allocated different from the one category; and
a third category region to which the one category and the another category are allocated, the third category region being adjacent to the first category region and the second category region.

15. The content selection apparatus according to claim 1, further comprising a GUI image generating unit configured to generate the GUI image of a circular shape, wherein
the GUI image generating unit generates the GUI image in which a category region to which a single category is allocated and a category region to which two categories are allocated are alternately arranged in a circumferential direction of the circular shape.

16. The content selection apparatus according to claim 15, wherein the category region to which two categories are allocated is allocated with two categories allocated to two category regions adjacent to each other in the circumferential direction of the circular shape.

17. The content selection apparatus according to claim 1, wherein:
the GUI image is of a circular shape; and
a region including a center of the circular shape to which all categories included in the circular GUI image are allocated.

18. The content selection apparatus according to claim 1, further comprising:
a time measuring unit configured to measure a selection time period that is a time period involved in the select manipulation input; and
a storage control unit configured to store information indicating the selection time period selected by a storage unit,
wherein the content selecting unit selects a predetermined content from a plurality of the content based on information indicating the selection time period.

19. A content selection method comprising:
a GUI image generating step of generating a GUI image including a plurality of category regions,
the category region being a region to which a category or a plurality of categories is allocated to sort a content item;
a selection determining step of determining whether a select manipulation input is input,
the select manipulation input being a manipulation input to select a predetermined range on a display screen on which the GUI image is displayed;
a selected region identifying step of identifying a region corresponding to a position selected by the select manipulation input;
a storage control step of storing selected category information indicating a selected category region identified at the selected region identifying step on a storage unit; and
a content selecting step of selecting a predetermined content item from a plurality of the content items based on the selected category information.

20. A non-transitory computer readable storage medium on which a content selection program is stored, the content selection program causing a computer to perform:
a GUI image generating step of generating a GUI image including a plurality of category regions,
the category region being a region to which a category or a plurality of categories is allocated to sort a content item;
a selection determining step of determining whether a select manipulation input is input,
the select manipulation input being a manipulation input to select a predetermined range on a display screen on which the GUI image is displayed;
a selected region identifying step of identifying a region corresponding to a position selected by the select manipulation input;
a storage control step of storing selected category information indicating a selected category region identified at the selected region identifying step on a storage unit; and
a content selecting step of selecting a predetermined content item from a plurality of the content items based on the selected category information.
